(19) United States
(12) Patent Application Publication
(10) Pub. No.: US 2011/0314950 A1
(43) Pub. Date: Dec. 29, 2011

(54) ROBOT

(75) Inventor: Takashi Mamba, Fukuoka (JP)

(73) Assignee: KABUSHIKI KAISHA YASKAWA DENKI, Kitakyushu-shi (JP)

(21) Appl. No.: 13/226,419

(22) Filed: Sep. 6, 2011

Related U.S. Application Data
(63) Continuation of application No. PCT/JP2010/053495, filed on Mar. 4, 2010.

(30) Foreign Application Priority Data
Mar. 6, 2009 (JP) 2009-053409

(51) Int. Cl. B25J 18/00

(52) U.S. Cl. 74/490.05; 901/26; 901/23; 901/15

(57) ABSTRACT

A robot includes an articulation mechanism that includes a pair of opposing bevel gears, a pair of motors that rotate the pair of opposing bevel gears independently of each other, an output bevel gear that is engaged with each of the pair of opposing bevel gears and is supported so as to be rotatable and so as to be swingable in rotational directions of the pair of opposing bevel gears, and an output body that is secured to the output bevel gear, a cover-and-support structure that is a supporting member and functions as a cover covering the outside of the entirety of the articulation mechanism, and a swing mechanism that supports the cover-and-support structure such that the cover-and-support structure is swingable in the rotational directions of the pair of opposing bevel gears.

### CROSS-REFERENCE TO RELATED APPLICATIONS

The present application is a continuation application of PCT/JP2010/053495, filed Mar. 4, 2010, which claims priority to Japanese Patent Application No. 2009-053409, filed Mar. 6, 2009. The contents of these applications are incorporated herein by reference in their entirety.

### BACKGROUND OF THE INVENTION

1. Field of the Invention

The present invention relates to a robot.

2. Description of the Related Art

In a typical articulated robot, an actuator (motor or the like) is assigned to a joint (mover), and when a joint operates while other joints are stopped, only the motor assigned to the joint in operation mainly performs the task while the motors not in operation are not effectively utilized. This is a general technical problem.

In order to solve this general technical problem, Japanese Patent No. 3282966 describes the following robot articulation mechanism. That is, a differential mechanism is used to intentionally cause outputs of two motors to interfere with each other so as to obtain an output torque from each output shaft up to two times the output torque that would otherwise be obtainable.

Japanese Unexamined Patent Application Publication No. 6-197492 also discloses a differential mechanism using bevel gears, in which motors are disposed in the bevel gears in order to reduce the differential mechanism in size.

### SUMMARY OF THE INVENTION

According to one aspect of the present invention, a robot includes an articulation mechanism that includes a pair of opposing bevel gears, a pair of motors that rotate the pair of opposing bevel gears independently of each other, an output bevel gear that is engaged with each of the pair of opposing bevel gears and is supported so as to be rotatable and so as to be swingable in rotational directions of the pair of opposing bevel gears, and an output body that is secured to the output bevel gear, a cover-and-support structure that is a supporting member and functions as a cover covering the outside of the entirety of the articulation mechanism, and a swing mechanism that supports the cover-and-support structure such that the cover-and-support structure is swingable in the rotational directions of the pair of opposing bevel gears.

### BRIEF DESCRIPTION OF THE DRAWINGS

The present invention will be described in further detail with reference to the accompanying drawings wherein:

FIG. 1 is a sectional view of an articulation unit of a first embodiment;

FIG. 2 is a sectional view of part of the articulation unit of a second embodiment;

FIG. 3 is a sectional view of part of the articulation unit of a third embodiment;

FIG. 4 illustrates the appearance of the articulation unit of the first to third embodiments;

FIG. 5 illustrates the appearance of a robot arm of a fourth embodiment; and

FIG. 6 illustrates the appearance of a robot arm of a fifth embodiment.

### DETAILED DESCRIPTION OF THE EMBODIMENTS

Embodiments will be described below with reference to the drawings.

### First Embodiment

A first embodiment will be described. FIG. 4 is a diagram of the appearance of an articulation unit 36 of the present embodiment. A cover-and-support structure 10 rotates about a horizontal axis A1 with a support disc 6b at the center, and an output body 9 rotates about a vertical axis A2.

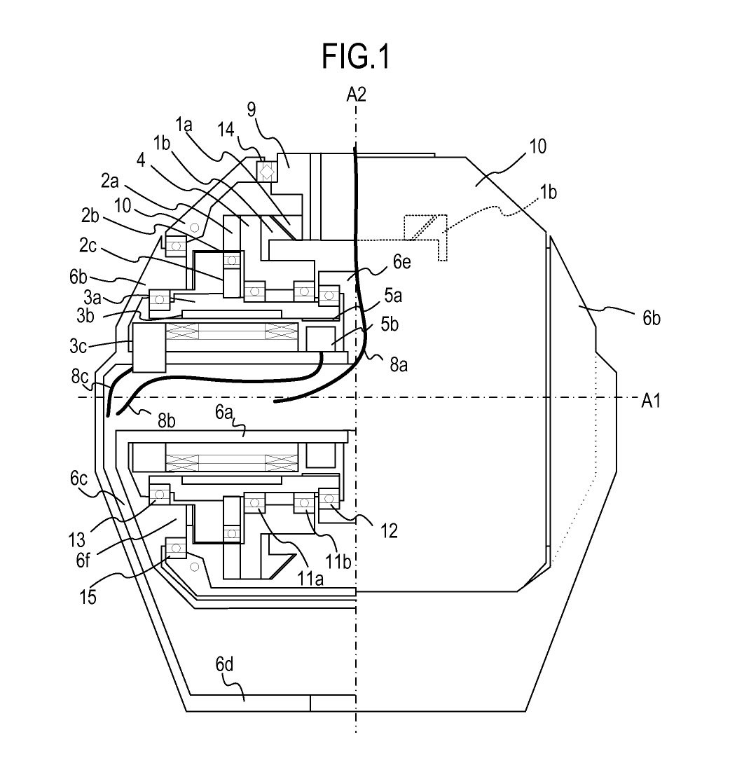

FIG. 1 is a sectional view of a differential articulation unit. In this figure, a bevel gear (output bevel gear) 1a integrally rotates with the output body 9, and bevel gears 1b (a pair of bevel gears) that are a pair of bevel gears symmetrically provided relative to the vertical axis A2 are separately driven by rotations of a pair of motors 3 (outer rotor motors), which will be described later (rotation axes parallel to the axis A1).

The support discs 6b include cylindrical portions 6e formed therein, which constitute part of an outer envelope of the articulation unit 36, are disposed so as to sandwich the pair of motors 3, and extend in a cylindrical shape from a disc-shaped region in the horizontal axis A1 direction (and inwardly in the articulation unit 36). Cylindrical portions 6e are made to be in contact with bearings 13 and bearings 15, which are described later.

An articulation mechanism that performs articulating operation includes the pair of bevel gears 1b, 1b, the pair of motors 3, 3, the bevel gear 1a, and the output body 9.

The motors 3 and the bevel gears 1b are provided in such a way that two sets of the motor 3 and the bevel gear 1b having similar structures are symmetrically disposed relative to the vertical axis A2.

Each outer rotor motor 3 is connected to the corresponding bevel gear 1b so as to allow each of the bevel gears 1b to be independently driven. A differential mechanism 1 includes the combination of the bevel gear 1a and the pair of bevel gears 1b. That is, with a rotational difference between the pair of bevel gears 1b, the output body 9 rotates about the rotation axis A2.

Reference numeral 2a denotes a circular spline, reference numeral 2b denotes a flexspline, and reference numeral 2c denotes a wave generator. These components are included in a strain wave gearing 2.

Reference numeral 3a denotes a motor rotor core, reference numeral 3b denotes a motor magnet, and reference numeral 3c denotes a motor coil. These components are included in the outer rotor motor 3. The motor coil 3c is secured to an outer periphery of a cylindrical hollow shaft 6a. The motor magnet 3b and the motor rotor core 3a are included in a rotor, which is rotated by a torque generated between the rotor and the motor coil 3c. The motor rotor core 3a is rotatably supported around the horizontal axis A1 using a bearing 12 and the bearing 13. The motor rotor core 3a is secured to the wave generator 2c and rotates the wave generator 2c.

The motor rotor core 3a and the wave generator 2c may be fabricated as a single component. Such a structure allows the resultant component to be further reduced in size. In other words, the motor magnet 3b may be directly secured to the wave generator 2c with adhesive or screws.

Rotation of the wave generator 2c is decelerated and transferred to the circular spline 2a. Reference numeral 4 denotes a rotary hollow cylinder, which is rotatably secured to an outer periphery of the motor rotor core 3a so as to be concentrically outside a motor shaft using bearings 11a and 11b.

The circular spline 2a and the bevel gear 1b are secured to the rotary hollow cylinder 4 and rotate at a decelerated speed.

Although the flexspline 2b is secured to the support disc 6b and the circular spline 2a is used as an output body in the present embodiment, the following structure may instead be used. That is, by horizontally flipping the whole strain wave gearing 2, the circular spline 2a is secured to the support disc 6b, and the flexspline 2b is used as an output.

With the differential articulation unit having a structure as above, a transport object attached to the end of the output body 9 can be rotated about the horizontal axis and the vertical axis. These two output axes are structured as an interference driven mechanism. Accordingly, the two axes can each generate an output up to two times the output with a single motor. The hollow shaft 6a is secured to the support disc 6b. The support disc 6b is connected to a support base 6d through a hollow support arm 6c.

A fixed component of an encoder 5b is secured inside the motor rotor core 3a and reads the scale of the encoder rotor 5a.

A support structure from the hollow shaft 6a to the support base 6d includes a hollow space penetrating therethrough, which allows wiring to be routed thereinside. The wiring includes a shown motor power cable 8c that supplies power to the motor coils 3c of the differential articulation unit, a shown encoder signal cable 8b that transfers a signal from the fixed component of the encoder 5b of the differential articulation unit to a controller, and so forth. The wiring also includes an external device cable 8a, which is wiring from a device such as another differential articulation unit connected to the end of the output body 9. The external device cable 8a is routed inside the hollow shaft 6a through a hollow space of the output body 9 and a hole formed at an upper area of the central fixed disc. Since the wiring can be routed near the vertical and horizontal rotation axes, the wiring is less likely to be loosened or stretched during the movement of the joint. Thus, durability in repetitive operation can be improved.

A robot and the articulation unit thereof of the first embodiment have the structure described as above. Thus, by disposing the strain wave gearing, which is typically disposed separately from the motor in the motor shaft direction, concentrically outside the outer rotor motor, the articulation unit can be reduced in size in the motor shaft A1 direction.

When the bevel gear 1b and another bevel gear that is not shown and disposed at a position symmetrical to the bevel gear 1b rotate in the same direction at the same speed, the bevel gear 1a does not rotate about the vertical axis A2. Instead, the bevel gear 1a rotates about the horizontal axis A1 integrally with the output body 9 and the cover-and-support structure 10 supported using the bearing 15. When the bevel gear 1b and the other bevel gear that is not shown and disposed at the position symmetrical to the bevel gear 1b rotate at different speeds, the bevel gear 1a rotates about the vertical axis A2 in accordance with the difference.

In FIG. 1, in order to transfer the rotation about the horizontal axis A1, the teeth of the bevel gear 1a support the whole torque. However, the torque may be supported by a plurality of gears in a distributed manner by providing freely rotating bevel gears at a plurality of positions in the lower side symmetrical to the bevel gear 1a or along the circumference of the bevel gear 1a. By doing this, damage to the teeth of the bevel gears can be reduced. The backlash can be also reduced by reducing the modules (dimensions) of the gears.

Furthermore, since a strain wave gearing is generally fabricated in a flat configuration more easily than a motor is, each bevel gear 1b is arranged adjacent to the strain wave gearing in the axial direction in the present embodiment. However, the wave generator 2c may be disposed adjacent to the motor 3 in the axial direction, and the bevel gear 1b may be disposed concentrically outside the circular spline 2a. In this case, the motor may not be an outer rotor motor.

As described above, the articulation unit of the present embodiment supports the bevel gear 1a with the cover-and-support structure 10, which is a supporting member and functions as a cover, without use of cross shafts. A hollow space having a size sufficient to contain the motor 3 is provided in the strain wave gearing 2, the strain wave gearing 2 is disposed concentrically outside the motor 3, and the hollow space is disposed concentrically outside the outer rotor motor 3 as a hollow space that is sufficiently large in order to receive the motor therein. The bearing 12 and the bearing 13, which support the rotor, are disposed concentrically outside an outer rotor motor stator as hollow spaces that are sufficiently large to receive the motor therein. The output body 9 and the hollow shaft 6a are formed so as to have hollow spaces through which the wiring is routed, and the hollow shaft 6a is fixed. Thus, gearings and bevel gears, which are disposed in the motor shaft directions in a typical articulation unit for a robot, can be contained in a nested manner, thereby reducing the articulation unit in size.

In addition, since drive force of the pair of motors 3 can be caused to collectively act on the horizontal axis A1 or the vertical axis A2, the maximum output torque of the horizontal axis A1 or vertical axis A2 with respect to the size of the articulation unit can be improved.

Thus, compared to the technology as disclosed, for example, in Japanese Unexamined Patent Application Publication No. 6-197492, the motors can be disposed as close to each other as possible due to the elimination of the bearings between the central cross shafts and the motors, and accordingly, the articulation unit can be reduced in size. Alternatively, due to the elimination of the bearings between the central cross shafts and the motors, encoders can instead be disposed in that space. In addition, since the shaft (output shaft) has a hollow inside space, the wiring can be routed therein. There is an advantage that the articulation unit is small in size and lightweight since the cover functions as the supporting member.

### Second Embodiment

Next, a second embodiment will be described. The present embodiment and the above-described first embodiment have a number of common features. Accordingly, explanations of features the same as those of the first embodiment are omitted from the description of the present embodiment, and the same reference numerals are used for similar components.

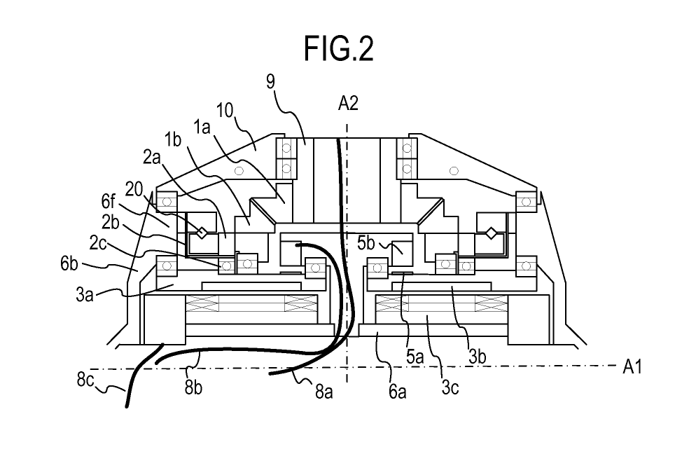

FIG. 2 is a sectional view of another embodiment of the articulation unit. Here, since the articulation unit has a structure that is symmetrical relative to the horizontal axis A2 except for the support arm, the support base, and the output body, only the upper half of the articulation unit is illustrated for the simplicity of the explanation. Also in FIG. 2, only one of each pair of components symmetrically disposed at the left and right is denoted by a reference numeral.

In the present embodiment, the wave generator 2c is integrated with the motor rotor core 3a. Reference numeral 2b denotes the flexspline. Unlike the strain wave gearing of the first embodiment, the present embodiment uses the strain wave gearing including the flexspline 2b having a flange opening toward the outside. Reference numeral 20 denotes a cross roller bearing. An outer ring of the cross roller bearing 20 is secured to the support disc 6b with the flexspline 2b disposed therebetween. The inner ring of the cross roller bearing 20 is secured to the circular spline 2a and rotates together with the bevel gear 1b. In the present embodiment, the wave generator 2c is disposed concentrically outside the outer rotor motor 3, and the bevel gear 1b is disposed further concentrically outside the circular spline 2a of the strain wave gearing.

The fixed component of the encoder 5b reads the scale of the encoder rotor 5a secured outside the motor rotor core 3a.

### Third Embodiment

Next, a third embodiment will be described. The present embodiment and the above-described first embodiment have a number of common features. Accordingly, explanations of features the same as those of the first embodiment are omitted from the description of the present embodiment, and the same reference numerals are used for similar components.

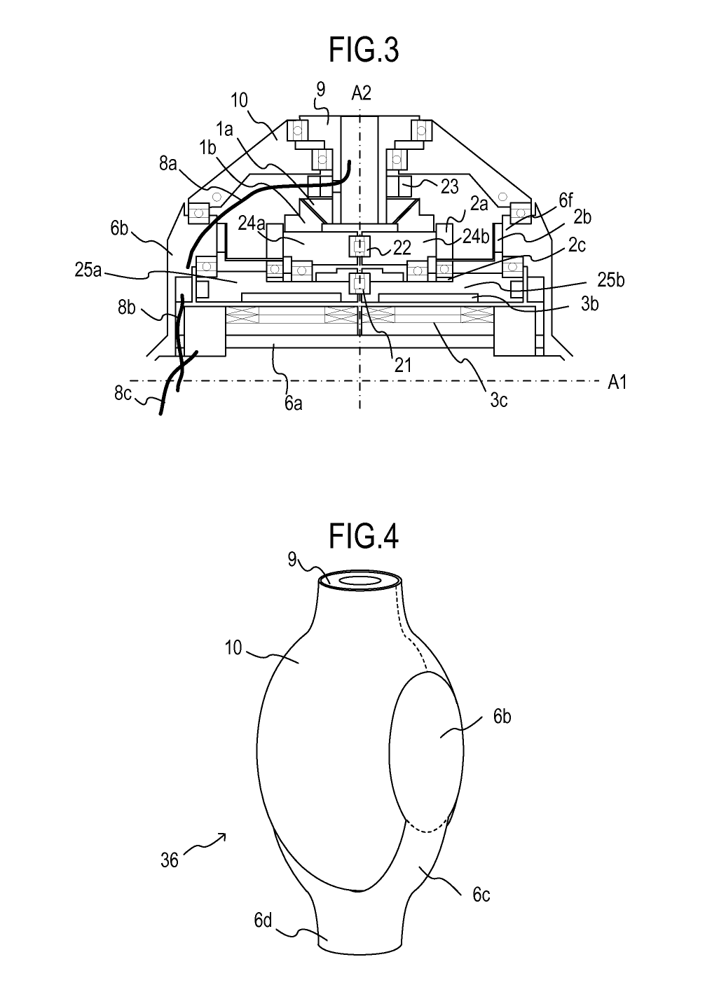

As illustrated in FIG. 3, since the articulation unit has a structure that is substantially symmetrical relative to the axis except for the support arm, the support base, and the output body, only the upper half of the articulation unit is illustrated. Also in FIG. 3, only one of each pair of components symmetrically disposed at the left and right is denoted by a reference numeral.

Reference numeral 21 denotes a roller bearing that supports loads of left and right motor rotor cores 25a and 25b in thrust and radial directions such that the left and right motor rotor cores 25a and 25b are rotatable relative to each other about the horizontal axis.

Reference numeral 22 is a roller bearing. Likewise, the roller bearing 22 supports loads of left and right rotary hollow cylinders 24a and 24b in thrust and radial directions such that the left and right rotary hollow cylinders 24a and 24b are rotatable relative to each other about the horizontal axis.

In the present embodiment, the roller bearing 21 and the roller bearing 22 are used. Alternatively, thrust bearings, four-point contact bearings, or the like may be used. It is sufficient that these bearings may have a structure that can support loads in the thrust and radial directions while being rotatable relative to each other.

Such a structure allows the pair of motors 3 to be disposed immediately close to each other, thereby eliminating dead space. Thus, the articulation unit 36 can be reduced in size, or output torques can be improved while keeping the size of the articulation unit.

The size in the motor shaft directions can be further reduced. Also in the present embodiment, a slip ring 23 is provided, and a hole is formed in the support disc 6b in order to route the external device cable 8a therethrough into the hollow shaft 6a. By doing this, the external device cable 8a can be disposed without being routed in a gap between the motors 3.

### Fourth Embodiment

Next, a fourth embodiment will be described. The present embodiment describes a seven-degree-of-freedom robot (robot arm) using the articulation units described in the first to third embodiments.

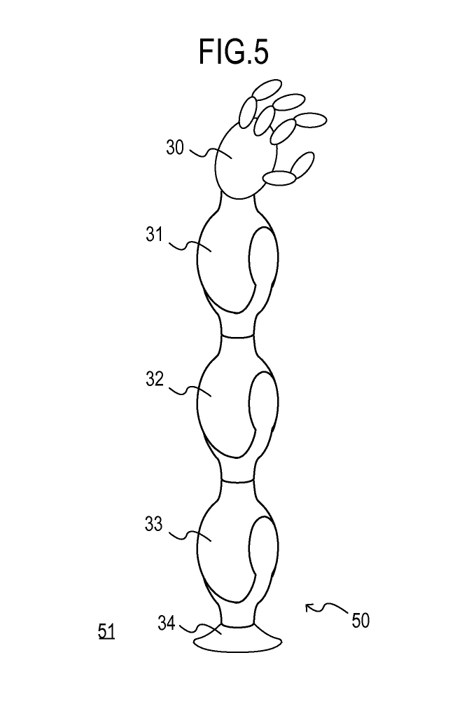

As illustrated in FIG. 5, a robot arm 50 includes a robot base with a swivel axis motor 34, an articulation unit a 31, an articulation unit b 32, an articulation unit c 33, and a hand 30.

The robot base with a swivel axis motor 34 is a base (pedestal) that secures the robot arm 50 to a fixed surface 51 (for example, a floor of a factory) and is provided with a motor that rotates the whole robot arm 50 about the vertical axis.

The articulation unit a 31, the articulation unit b 32, and the articulation unit c 33 are connected in series. Reference numeral 30 denotes the hand that is an end effecter, of which the position and the attitude are controlled by this robot arm 50, performing tasks such as transportation, assembly, and welding.

Due to the structure of the present embodiment as above, a seven-degree-of-freedom vertical articulated robot is achieved, of which the maximum output is improved while the robot arm 50 is reduced in size (particularly, in thickness).

### Fifth Embodiment

Next, a fifth embodiment will be described. As in the case with the fourth embodiment, the articulation unit described in the first to third embodiments is also applied to the robot (robot arm) in the present embodiment.

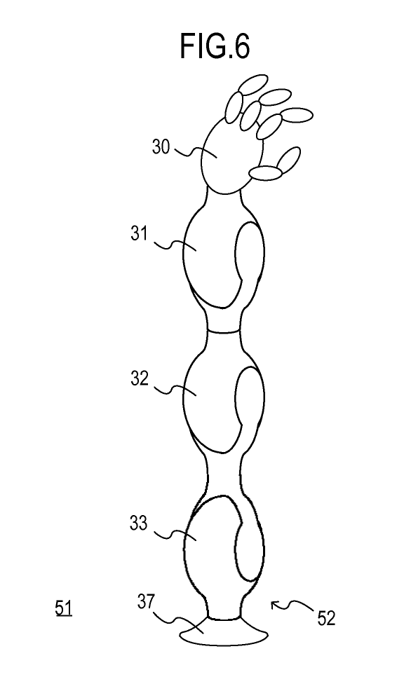

FIG. 6 is a diagram of the appearance of a six-degree-of-freedom robot arm using the articulation units.

As described in FIG. 6, a robot arm 52 includes a robot base 37, the articulation unit a 31, the articulation unit b 32, the articulation unit c 33, and the hand 30.

The robot base 37 is a base that secures the robot arm 50 to the fixed surface 51 (for example, a floor of a factory).

In the present embodiment, the orientation of the articulation unit c 33 is reversed compared to that in the fourth embodiment. That is, the support base 6d of the articulation unit a 31 is connected to the output body 9 of the articulation unit b 32, the support base 6d of the articulation unit b 32 is connected to the support base 6d of the articulation unit c 33, and the output body 9 of the articulation unit c 33 is secured to the robot base 37.

Due to the structure of the present embodiment as above, a six-degree-of-freedom vertical articulated robot is achieved, of which the maximum output is improved while the robot arm 50 is reduced in size (particularly, in thickness).

According to each of the embodiments, by unitizing the joint, a small lightweight two-degree-of-freedom drive mechanism is achieved. This technology is applicable to pet robots movable with wheels or legs, home use robots including humanoid robots, service robots, and entertainment robots. The technology is also applicable to machine tools, construction machines, angle and attitude controllers of measurement instruments for cameras and laser mirrors, and so forth.

What is claim is:

1. A robot comprising:
an articulation mechanism that includes
a pair of opposing bevel gears,
a pair of motors that rotate the pair of opposing bevel gears independently of each other,
an output bevel gear that is engaged with each of the pair of opposing bevel gears and is supported so as to be rotatable and so as to be swingable in rotational directions of the pair of opposing bevel gears, and
an output body that is secured to the output bevel gear;
a cover-and-support structure that is a supporting member and functions as a cover covering the outside of the entirety of the articulation mechanism; and
a swing mechanism that supports the cover-and-support structure such that the cover-and-support structure is swingable in the rotational directions of the pair of opposing bevel gears.

2. The robot according to claim 1, further comprising:
a pair of support discs that are disposed so as to sandwich the pair of motors and each have a cylindrical portion therein,
wherein the support discs support the cover-and-support structure with outer surfaces of the cylindrical portions using bearings.

3. The robot according to claim 1, further comprising:
a pair of strain wave gearings that respectively increase torques of the pair of motors,
wherein each of the pair of motors is an outer rotor motor, in which a rotor is disposed outside a stator,
wherein the strain wave gearings each have a hollow in a wave generator thereof, the hollows containing the respective outer rotor motors, the wave generators being inputs of the respective strain wave gearings,
wherein the wave generators are secured concentrically outside the rotors of the respective outer rotor motors, and
wherein the pair of opposing bevel gears are secured to members that integrally rotate with circular splines or flexsplines, the circular splines or the flexsplines being output bodies of the pair of strain wave gearings.

4. The robot according to claim 3,
wherein second bearings that support the circular splines or the flexsplines each have a hollow that contains the corresponding outer rotor motor therein, and
wherein the second bearings are disposed concentrically outside the rotors of the respective outer rotor motors.

5. The robot according to claim 1,
wherein the pair of bevel gears each have a hollow therein that contains an outer rotor motor, in which a rotor is disposed outside a stator, the hollow being disposed concentrically outside the outer rotor motor.

6. The robot according to claim 1,
wherein each of the pair of motors is an outer rotor motor, in which a rotor is disposed outside a stator,
wherein third bearings, which support the rotors of the outer rotor motors such that the rotors are rotatable, are provided, and
wherein the third bearings each have a hollow therein that contains the corresponding outer rotor motors, the bearing being disposed concentrically outside the stator of the outer rotor motor.

7. The robot according to claim 1,
wherein the output bevel gear and the output body each have a hollow formed therein, the hollows allowing wiring to be routed therethrough.

8. The robot according to claim 1,
wherein the output is rotatably supported with an output support bearing from the outside of a rotation axis thereof, and
wherein a slip ring is provided between the output body support bearing and the output bevel gear.

9. The robot according to claim 1,
wherein a hollow that allows wiring to be routed therethrough is formed in each of the pair of bevel gears and each of the pair of motors.

10. The robot according to claim 9, further comprising:
a cooling fan that blows air toward the hollow in each of the pair of opposing bevel gears and each of the pair of motors so as to cool the pair of motors.

11. The robot according to claim 9, further comprising:
a support base having a hollow space formed therein; and
a pair of hollow support arms that route wiring toward the support base, the wiring having been routed through the pair of motors and divided into left and right.

12. The robot according to claim 11, further comprising:
a pair of encoders that detect positions of the rotors of the pair of motors,
wherein encoder circuitry is disposed in the hollow space in the support base, the encoder circuitry processing encoder signals of the pair of encoders and transmitting resultant signals to an upper level controller.

13. The robot according to claim 1, further comprising:
a robot base that secures the articulation mechanism to an installation position.

14. The robot according to claim 1,
wherein three articulation units are arranged in series, each articulation unit including the articulation mechanism, the cover-and-support structure, and the swing mechanism,
wherein two out of the three articulation units are oriented so as to allow a support base, which has a hollow space formed therein, of one of the two articulation units to be fastened to the output body of the other articulation unit, and
wherein the support base of the remaining one articulation unit is fastened to the support base of one of the two articulation units.

15. The robot according to claim 14, further comprising:
a robot base with a swivel axis motor, one surface of the robot base being secured to the floor surface or the body of the robot, the robot base being provided with a motor that rotates the other surface of the robot base about an axis vertical to the secured surface,
wherein the three articulation units for a robot are connected in series with the support bases fastened to the output bodies, except the support base of the terminal articulation unit is fastened to the robot base with the swivel axis motor.
